(19) United States
(12) Patent Application Publication
(10) Pub. No.: US 2011/0149164 A1
(43) Pub. Date: Jun. 23, 2011

(54) METHOD CIRCUIT AND SYSTEM FOR MITIGATING INTERFERENCE BETWEEN WIRELESS DATA AND WIRELESS VIDEO TRANSCEIVERS OPERATING IN PROXIMITY WITH ONE ANOTHER

(76) Inventors: Netanel Goldberg, Zichron Yaakov (IL); Lior Ophir, Herzlia (IL); Shlomo Arbel, Shoham (IL)

(21) Appl. No.: 13/059,978

(22) PCT Filed: Aug. 26, 2009
(86) PCT No.: PCT/IB2009/053740

§ 371 Date: Feb. 20, 2011

Related U.S. Application Data
(60) Provisional application No. 61/091,760, filed on Aug. 26, 2008.

(51) Int. Cl. H04N 5/00

(52) U.S. Cl. 348/607; 348/E05.001

(57) ABSTRACT

Disclosed is a circuit including a wireless data communication circuit, a wireless video communication circuit, and control logic functionally associated with either of the circuits and adapted to mitigate interference between transmissions of one of the circuits with reception by the other circuit.

### FIELD OF THE INVENTION

The present invention relates generally to the field of wireless video and wireless data communication. More specifically, the present invention relates to methods, circuits and systems for mitigating interference between wireless video transceivers and wireless data transceivers operating in proximity with one another.

### BACKGROUND

AudioNideo systems have come a long way since the broadcast of the first radio program on Aug. 31, 1920 and since televisions became commercially available in the 1930's. The evolution of multimedia entertainment and communication has been constant and extensive.

In the 1950's, home movies became popular in the United States and elsewhere as Kodak 8 mm film (Path 9.5 ′mm in France) and camera and projector equipment became affordable. Projected with a small, portable movie projector onto a portable screen, often without sound, this system became the first practical home theater. They were generally used to show home movies of family travels and celebrations. Dedicated home cinemas were called screening rooms at the time and were outfitted with 16 mm or even 35 mm projectors for showing commercial films.

Portable home cinemas improved over time with color film, Kodak Super 8 mm film cartridges, and monaural sound but remained awkward and somewhat expensive. The rise of home video in the late 1970s almost completely killed the consumer market for 8 mm film cameras and projectors, as VCRs connected to ordinary televisions provided a simpler and more flexible substitute.

The development of multi-channel audio systems and laserdisc in the 1980s added new dimensions for home cinema. By the early to mid 90's, a typical Home Cinema would have a Laserdisc or S-VHS player fed to a large screen: rear projection for the more affordable setups, and LCD or CRT front projection in the more elaborate. In the 1990s, there were developments such as DVD, 5.1-channel audio, and high-quality video projectors that provide a cinema experience at a price that rivals a big-screen.

HDTVs sparked a new wave of home cinema interest. In the 2000s, developments such as High Definition video, Blu-ray Disc and newer HD display technologies brought even higher quality AudioNideo (“NV”) to the general public. There has been a proliferation of the quality and quantity of A/V devices (i.e. Media Device) in the home or office.

Given that it may be desirable to place a display, screen or projector at a location at a distance of a few meters from a video source (e.g. Set top box, DVD, computer) and that connection of such a display or projector to the video source through cables is generally undesired for aesthetic reasons and/or installation convenience, wireless transmission of the video signals from the video source to the screen has been developed. The WHDI standard is based on technology pioneered by Amimon LTD. and it has been adopted by the industry for wireless transmission/reception of high definition video from (HD) video sources to (HD) video sinks. HID video sink devices may be integral with or otherwise functionally associated with a WHDI receiver, which may also include an uplink transmitter. HD video source devices may be integral with or otherwise functionally associated with a WHDI transmitter, which may also include a uplink receiver.

There has also been a proliferation of quality and quantity of equipment that supports wireless data communication such as: cell phones, personal computers, game consoles and more. It is not uncommon to see a coffee shop filled with people using the internet on their laptop computers with no cables or wires needed because the connection to the Internet is done through wireless communication such as wireless-local-area-network (WLAN). The predominant standard for wireless data communication is WIFI. The convenience of wireless data communication has brought the (e.g. WIFI based) technology into the home and office allowing several laptop computers, game consoles, personal digital assistants (PDAs) all to connect to a wireless data communication access point. Numerous appliances, including televisions and laptop computers, come with built in wireless data transceivers. Wireless data access points are also readily found in offices, homes and public spaces.

With the proliferation of both wireless data and wireless video transmission devices, the likelihood of both being utilized in proximity with one another is increasing. There are even suggestions to provide both wireless video and wireless data functionality in the same appliances, using both types of transceivers integrated into the same device, and possibly on the same printed circuit board or semiconductor die. However, wireless video transmission and wireless data transmission performed in proximity of one another may lead to one transceivers interfering with the other. For example, a transmission by one may saturate a wideband amplifier on the receive chain of the other.

There is thus a need for methods, circuits and systems to mitigate the possible interference between wireless video and wireless data transceivers.

### SUMMARY OF THE INVENTION

The present invention is a method circuit and system for mitigating interference between wireless data and wireless video transceivers operating in proximity with one another. According to some embodiments of the present invention, the methods, circuits and systems provided may facilitate substantially concurrent operation of wireless video and data communication transceivers. According to further embodiments of the present invention, a wireless data communication circuit (for example: a circuit operating in compliance with the WIFI standard) and a wireless video communication circuit (for example: a circuit operating in compliance with the WHDI standard) may operate in proximity to one another and/or may reside on the same printed circuit or integrated circuit die. Interference between transmission from one of the circuits (for example: transceivers) with reception by the other circuit may be mitigated by an interference mitigation circuit (“IMC”) functionally associated with either or both of the circuits. The IMC may be integral or otherwise functionally associated with the wireless video communication circuit, with the wireless data communication circuit, or with both. The IMC may include a control logic circuitry in form of an integrated circuit segment (e.g. controller), a computer and more. The IMC may be composed of logic circuitry integral with or otherwise functionally associated with both the video communication circuit and the data communication circuit.

According to some embodiments, a wireless data communication circuit may function as a receiving and/or transmitting circuit, and a wireless video communication circuit may be a wireless video communication receiver/sink circuit or a wireless video communication transmitter/source circuit. Optionally, a wireless video communication sink circuit may include an uplink transmitter, and may transmit back to a source, for example confirmation data (such as control signaling) associated with video transmission in compliance with the WHDI standard.

According to some embodiments, if a wireless data communication circuit needs to transmit while a wireless video communication sink circuit is receiving at a first band (an exemplary band may be 5 Ghz but not limited to this example), an IMC may cause the data communication circuit to transmit at a second band (an exemplary band may be 2.4 GHz but not limited to this example). Optionally, the video sink circuit entering into a video sink reception session may cause the IMC to trigger the data communication circuit into a state where the data communication circuit transmits at a second band.

According to some embodiments, an IMC may wait for a video sink to experience a quiet period (i.e. period while the video sink transceiver is not receiving a signal) before enabling a data communication circuit to transmit a signal. Optionally, if the data communication circuit receives a transmission during the video communication circuit's reception cycle/period (Le. video sink transceiver is receiving a signal), the IMC may signal the data communication circuit to suppress transmissions of any acknowledgement(s). Optionally, the data communication circuit may wait for retransmission of unacknowledged transmission. Optionally, while the video sink transceiver is experiencing a quiet period, the IMC may cause the data communication circuit to request retransmission of any unacknowledged transmission(s).

According to some embodiments, pre-amplifier (“pre-amp”) filters associated with a video sink transceiver may be activated so as to mitigate interference from transmissions of the data communication module. The video sink may trigger the pre-amp filters during reception or the filters may be continuously active. Optionally, the data communication circuit may signal to an IMC that it is about to transmit and the (MC may cause the pre-amp filters on the video sink transceiver to be activated. Optionally, transmission of data by a data communication circuit may be detected by the IMC and the IMC may trigger the filters on the video sink transceiver.

According to some embodiments, pre-amp filters associated with a wireless data communication circuit may be activated to mitigate interference from transmission by video communication circuit, sink or source transceiver. The wireless data communication circuit may trigger a filter(s) during reception, or a filter(s) may be continuously active. Optionally, the video communication circuit may signal an IMC that it is about to transmit, thereby triggering the IMC to cause the data communication circuit filters to activate. Optionally, transmission of a video communication signal may cause the IMC to trigger the pre-amp filters. Optionally, an IMC may track the video sink reception/transmission cycles.

According to some embodiments, an IMC may limit transmission power of a video communication circuit, sink or source transceiver, while a data communication circuit is receiving. The transmission power of the video circuit may be may be limited to a predefined level, for example, a transmission power of approximately 0 dBm.

According to some embodiments, an IMC may limit transmission power of the data circuit while a video communication circuit is receiving a signal. The transmission power of the data circuit may be limited to a predefined level, for example, a transmission power of approximately 0 dBm.

According to some embodiments, a wireless data communication circuit may function as a receiving and/or transmitting circuit and a wireless video communication circuit may be a wireless video communication transmitter/source circuit.

According to some embodiments, if a wireless data communication circuit needs to operate (for example: receive data or ACKs) while a wireless video communication source circuit is transmitting at a first band (an exemplary band may be 5 Ghz but not limited to this example), an IMC may trigger the data circuit to operate at a second band (an exemplary band may be 2.4 GHz but not limited to this example). Optionally, an initiation of a wireless video communication session by a source circuit may trigger the IMC to cause the wireless data communication circuit to operate at a second band.

According to some embodiments, an IMC may suppress the wireless data communication circuit from transmitting a signal during a quiet period of a video source, for example, during periods when a video sink associated with the source is transmitting uplink information. Optionally, if the data circuit receives a transmission during a quiet period of the video source, the IMC may signal the data communication circuit to suppress acknowledgement(s) signal(s). Optionally, the data circuit may wait for retransmission of unacknowledged transmission(s). Optionally, during video source transmission cycle/period the IMC may cause the data circuit to request retransmission.

According to some embodiments, pre-amp filters associated with wireless data communication circuit may be activated so as to mitigate interference from nearby video communication circuit transmissions. The wireless data communication circuit may trigger a filter(s) during reception, or a filter(s) may be continuously active. Optionally, the video source may signal to an IMC that it is about to transmit, which in turn may cause an IMC to trigger filter(s) on the data communication module. Optionally, the IMC and/or the data circuit may sense transmission of a wireless video communication signal, which sensing may cause an IMC to trigger the filter(s). Optionally, the (MC may track the video source reception/transmission cycles.

According to some embodiments, an IMC may limit transmission power of a data circuit while it is transmitting if a video source is concurrently receiving a signal. The transmission power may be limited to a predefined level, for example, a transmission power of approximately 0 dBm.

According to some embodiments, an IMC may limit transmission power of a video source transceiver while a wireless data communication circuit is receiving. The transmission power may be limited to a predefined level, for example, a transmission power of approximately 0 dBm.

According to some embodiments of the present invention, there may be provided a wireless video stream transceiver (source or sink side) including a port/connector (e.g. Ethernet port) for packet (e.g. TCP/IP) data. According to some embodiments of the present invention, the data packet network port/connector may be functionally associated with network device emulation circuitry adapted to emulate a packet network switch, router, bridge or any other network device. The emulation circuitry may be functionally associated with a data insertion circuit which is adapted to insert data received through the data packet network port/connector into a video transmission signal/stream generated by a wireless video stream transceiver. According to further embodiments of the present invention, either the emulation circuit or the insertion circuit may include or otherwise be functionally associated with a data buffer. According to further embodiments of the present invention, buffered packet data may be inserted into the wireless video stream in between bursts of wireless video data.

According to some embodiments of the present invention, packet data may be inserted into the blanking intervals (e.g. vertical blanking interval) of the wireless video signal/stream. According to some embodiments of the present invention, packet data may be inserted into the video stream during intervals associated with static video blocks or frames, which static video blocks/frames generally require relatively smaller data payloads per interval than dynamic blocks/frames.

According to some embodiments of the present invention, a wireless video stream transceiver may be functionally associated with a data extraction circuit to extract data packets from a received video signal/stream. According to further embodiments of the present invention, data packets may be reconstructed from the extracted data and optionally, the reconstructed packets may be buffered. Reconstructed packets may be provided to a functionally associated network device emulation circuitry adapted to emulate a packet network switch, router, bridge or any other network device. The emulation circuit may transmit the data out of a data packet network port/connector in compliance with data network protocols.

According to some embodiments of the present invention, a wireless video stream transceiver source may have a portion of its allotted bandwidth dedicated to downlink transmission providing sufficient bandwidth for transmitting packet data. According to further embodiments of the present invention, the wireless video stream transceiver source may not have bandwidth allotted for receiving data through its uplink. According to further embodiments of the present invention, packet data may be received during blanking intervals of the video stream or video transmission off-time to offset the lack of bandwidth dedicated for the uplink.

According to some embodiments of the present invention, a wireless video stream transceiver sink may have a portion of its allotted bandwidth dedicated to receiving data along its uplink providing sufficient bandwidth for receiving packet data within the video stream. According to further embodiments of the present invention, the wireless video stream transceiver sink may not have significant bandwidth allotted for downlink transmission. According to further embodiments of the present invention, packet data may be transmitted during blanking intervals of the video stream or video transmission off-time to offset the lack of bandwidth dedicated for the downlink.

According to some embodiments of the present invention, the wireless video stream transceiver may be functionally associated with a network bridge (e.g. access point) to handle data link layer routing of packet data. According to further embodiments of the present invention, the network bridge may be designed with medium access control to enable concurrent operation in multiple active networks.

According to some embodiments of the present invention, data packet downlink speed may exceed 180 mbps.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows a block diagram of a communication system; and

FIG. 1B shows a block diagram of a communication system; and

FIG. 1C shows a block diagram of a communication system; and

FIG. 2 shows a block diagram of a communication system.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CID-ROMs, magnetic-optical disks, read-only memories (ROMs), random access memories (RAMS) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

As both wireless video communication and wireless data communication become more and more common in our daily lives and new technologies and solutions come to market, so do the occurrences that products that support wireless video communication and products that support wireless data communication are placed near each other or even integrated into a single product. A possible outcome may be that one of the products will interfere with transmission or reception of communication by the other product. For example, it may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred. A further wireless data communication module may be placed on or near the video display (sink) thus disrupting video reception. In a different example an additional wireless data communication module may be placed near the video source, in this situation the wireless video communication may interfere with wireless data communication reception.

There may be provided a circuit including a wireless data communication circuit, a wireless video communication circuit, and control logic functionally associated with either of said circuits and adapted to mitigate interference between transmission from one of said circuits with reception by the other circuit. The wireless data communication circuit may be a packetized data transceiver circuit. The wireless data communication circuit may be a WiFi compliant transceiver circuit. The video communication circuit may be a wireless video sink transceiver circuit and may be adapted to receive a wireless video transmission. The control logic may be adapted to signal the data transceiver circuit to operate in a second band mode when the video sink transceiver circuit is receiving a video transmission. The control logic may be adapted to disable transmission by the data transceiver circuit when the video sink transceiver circuit is receiving a video transmission. The control logic may be adapted to activate one or more pre-amp filters associated with the video sink transceiver circuit when the data transceiver circuit is transmitting. The control logic may be adapted to activate one or more pre-amp filters associated with the data transceiver circuit when the video sink circuit is transmitting.

The video communication circuit may be a wireless video source transceiver circuit and may be adapted to transmit a wireless video transmission. The control logic may be adapted to cause the data communication circuit to operate in a second band mode when said video source circuit is transmitting. The control logic may be adapted to disable transmission by the data communication circuit when the video source transceiver circuit is receiving a transmission. The control logic may be adapted to activate pre-amp filters associated with the data communication circuit when said video source transceiver circuit is transmitting a video transmission.

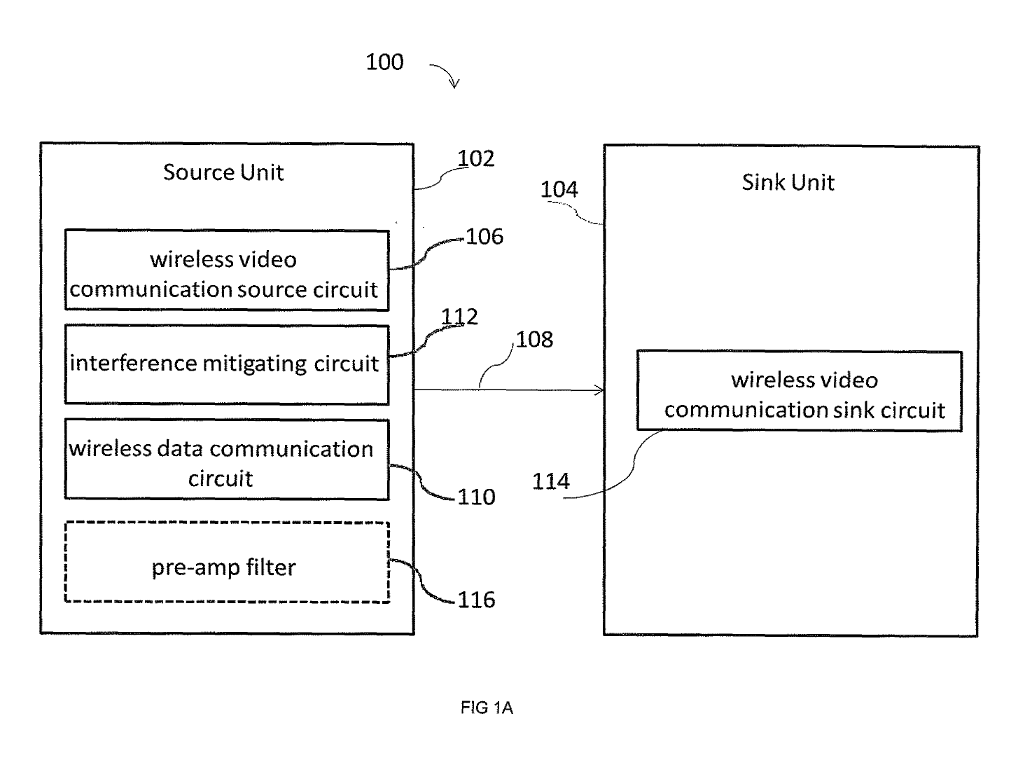

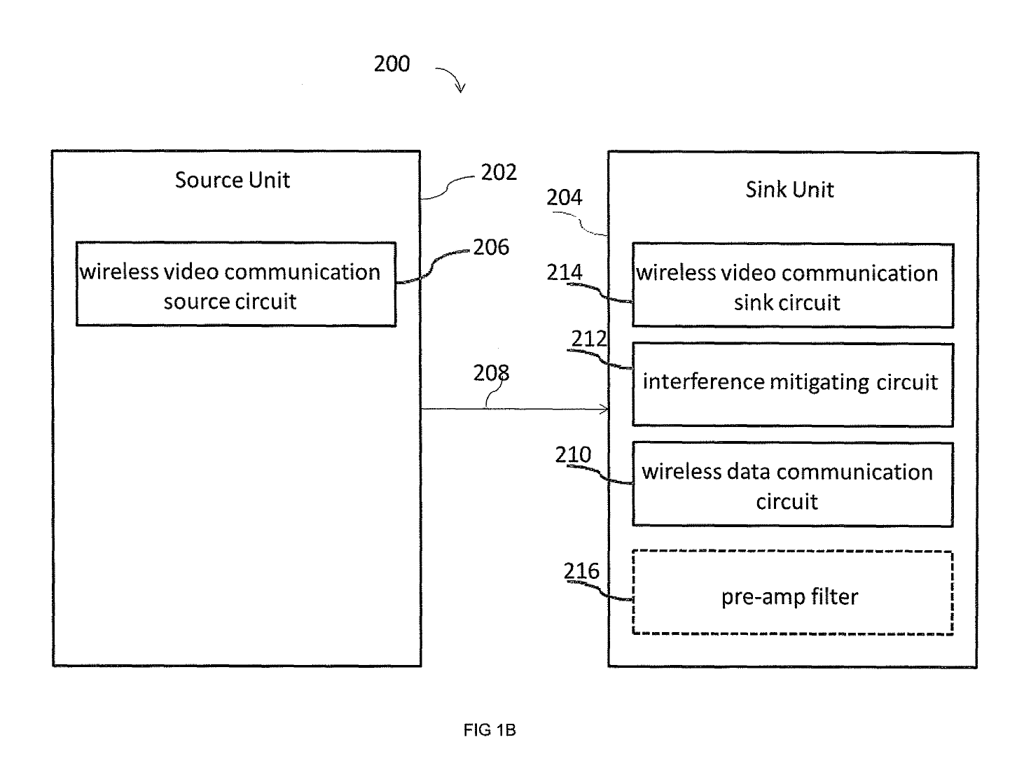

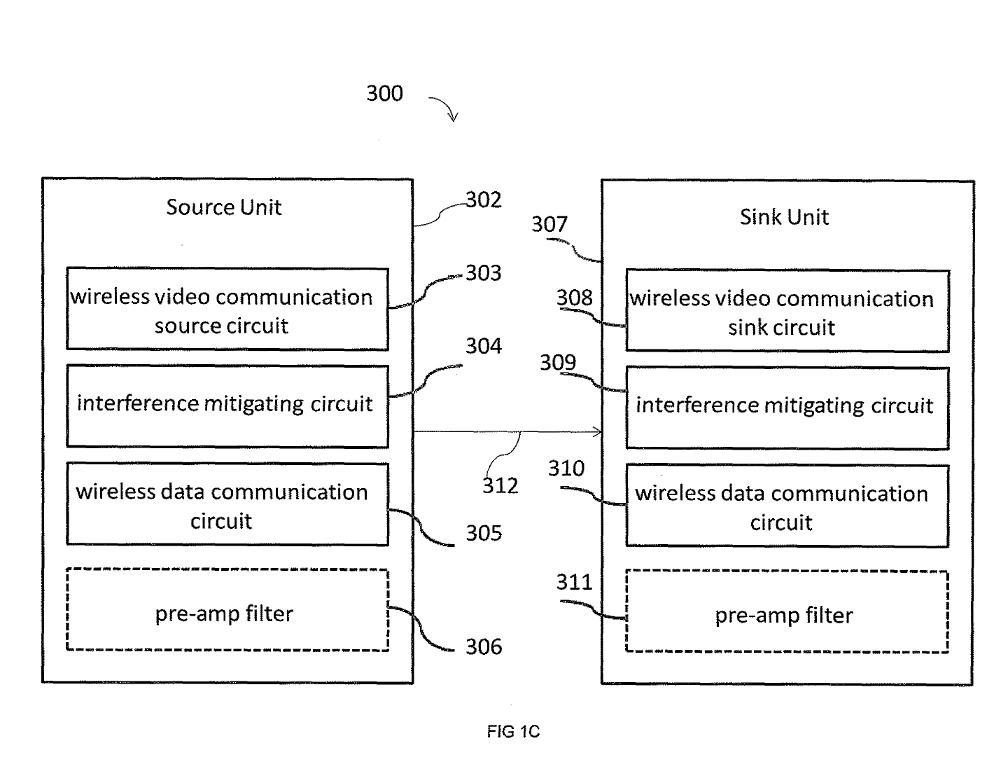

Turning now to FIG. 1A, there is shown a communication system such as wireless communication system 100. Wireless communication system 100 may trigger communication, transmission, and/or reception of wireless video communication, wireless data communication, wireless multimedia communication and more. Wireless communication system 100 may be situated completely in a home, office or public setting or may be split between a local and remote configuration.

Wireless communication system 100 is further comprised of a source unit such as source unit 102 which is adapted to transmit to a sink unit such as sink unit 204. Source unit 102 may be a Set-Top Box (STB), a television, video Accessories, Digital-Versatile-Disc (DVD), multimedia projectors, Audio and/or Video (A/V) transmitters, gaming consoles, video cameras, video recorders, portable media players, cell phones, mobile devices, and/or automobile NV accessories, Personal Computers (PC) such any suitable desktop PC, notebook PC, monitor, and/or PC accessories and more but not limited to these examples. Sink unit 204 may be a television, video Accessories, Digital-Versatile-Disc (DVD), Audio and/or Video (A/V) receivers, gaming consoles, video cameras, video recorders, portable media players, cell phones, mobile devices, and/or automobile A/V accessories, a Personal Computers (PC), such as a desktop PC, notebook PC, monitor, and/or PC accessories and more but not limited to these examples.

Sink unit 204 may comprise a wireless video communication sink such as video sink 114. Video sink 114 may receive a video signal such as video signal 108 which may include High Definition Television (HDTV) video signals, uncompressed HDTV signals, video signals in compliance with a Digital Video Interface (DVI) format, a High Definition Multimedia Interface (HDMI) format, a Video Graphics Array (VGA), a VGA DB-15 format, an Extended Graphics Array (XGA) format, and their extensions, and more but not limited to these examples.

Source unit 102 may comprise a wireless video communication source circuit such as video source 106. Video source 106 may transmit a video signal such as video signal 108. Source unit 102 may further comprise a wireless data communication circuit such as wireless data communication circuit 110. Wireless data communication circuit 110 may comply with the WIFI standard, but not limited to these examples. Wireless data communication circuit 110 may both receive and transmit data. Source unit 102 may further comprise an IMC such as IMC 112 which may be associated with wireless data communication circuit 110 and/or video source 106. Optionally, IMC 112 may be integral to wireless data communication circuit IMC 112 and may include control logic capable of carrying out interference mitigation decisions and/or steps, which decision and/or steps may be based on predetermined rules and/or may depend on input signals from one or more of the other circuit segments.

IMC 112 may mitigate interferences so that wireless data communication circuit 110 may receive adequate signals while video source 106 is transmitting.

According to some embodiments, if wireless data communication circuit 110 needs to transmit while video source 106 is receiving at a first band (an exemplary band may be 5 Ghz but not limited to this example), IMC 112 may cause wireless data communication circuit 110 to transmit at a second band (an exemplary band may be 2.4 GHz but not limited to this example). Optionally, video sink 114 reception session activation may trigger IMC 112 to wireless data communication circuit 110 to transmit at a second band.

According to some embodiments, of the present invention if wireless data communication circuit 110 needs to operate while video source 106 is transmitting at a first band (an exemplary band may be 5 Ghz but not limited to this example), the IMC 112 may trigger the wireless data communication circuit 110 to operate at a second band (an exemplary band may be 2.4 GHz but not limited to this example). Optionally, initiation of a wireless video communication by video source 106 may trigger the IMC 112 to cause wireless data communication circuit 110 to operate at a second band.

According to some embodiments, IMC 112 may suppress the wireless data communication circuit 110 from transmitting a signal during a quiet period of video source 106, for example, the video sink 114 associated with it is transmitting to it. Optionally, if the wireless data communication circuit 110 receives a transmission during a quiet period of video source 106, IMC 112 may control the wireless data communication circuit 110 so as to suppress sending acknowledgement. Optionally, wireless data communication circuit 110 may wait for retransmission of unacknowledged transmission. Optionally, during video source 106 transmission cycle/period IMC 112 may trigger wireless data communication circuit 110 to request retransmission.

Optionally, source unit 102 may further comprise a pre-amp filter such as pre-amp filter 116. Pre-amp filter 116 may be associated with wireless data communication circuit 110 and may be activated so as to mitigate interference. Wireless data communication circuit 110 may trigger pre-amp filter 116 during reception or pre-amp filter 116 may be continuously active. Optionally, video source 106 may signal to IMC 112 that it is about to transmit or wireless data communication circuit 110 may sense transmission of a signal associated with wireless data communication circuit 110 upon any of which the IMC 112 may trigger pre-amp filter 116. Optionally, IMC 112 may track video source 106 reception/transmission cycles.

According to some embodiments, the IMC 112 may limit transmission power of video source 106 during the transmission cycle/period if wireless data communication circuit 110 is receiving. The transmission power may be may be limited to a predefined level, for example,

According to some embodiments, the IMC 112 may limit transmission power of the wireless data communication circuit 110 during video source 106 reception cycle/period. The transmission power may be limited to a predefined level, for example, a transmission power of approximately 0 dBm.

Turning now to FIG. 1B, there is shown a communication system such as wireless communication system 200. Wireless communication system 200 may trigger communication, transmission, and/or reception of wireless video communication, wireless data communication, wireless multimedia communication and more. Wireless communication system 200 may be situated completely in a home, office or public setting or may be split between a local and remote configuration.

Wireless communication system 200 is further comprised of a source unit such as source unit 202 which is adapted to transmit to a sink unit such as sink unit 204. Source unit 202 may be a Set-Top Box (STB), a television, video Accessories, Digital-Versatile-Disc (DVD), multimedia projectors, Audio and/or Video (A/V) transmitters, gaming consoles, video cameras, video recorders, portable media players, cell phones, mobile devices, and/or automobile A/V accessories, Personal Computers (PC) such any suitable desktop PC, notebook PC, monitor, and/or PC accessories and more but not limited to these examples. Sink unit 204 may be a television, video Accessories, Digital-Versatile-Disc (DVD), Audio and/or Video (A/V) receivers, gaming consoles, video cameras, video recorders, portable media players, cell phones, mobile devices, and/or automobile A/V accessories, a Personal Computers (PC), such as a desktop PC, notebook PC, monitor, and/or PC accessories and more but not limited to these examples.

Sink unit 204 may comprise a wireless video communication sink such as wireless video sink circuit 214. Wireless video communication sink circuit 214 may receive a video signal such as video signal 208 which may include High Definition Television (HDTV) video signals, uncompressed HDTV signals, video signals in compliance with a Digital Video Interface (DVI) format, a High Definition Multimedia Interface (HDMI) format, a Video Graphics Array (VGA), a VGA DB-15 format, an Extended Graphics Array (XGA) format, and their extensions, and more but not limited to these examples.

Sink unit 204 may further comprise a wireless data communication circuit such as wireless data communication circuit 210. Wireless data communication circuit 210 may comply with the WIFI standard, but not limited to this example. Wireless data communication circuit 210 may both receive and transmit data. Sink unit 204 may further comprise an interference mitigating circuit such as interface mitigating circuit 212 which may be associated with wireless data communication circuit 210 and/or video communication sink circuit 214. Optionally, interference mitigating circuit 212 may be integral to wireless data communication circuit 210 and/or wireless video communication sink circuit 214.

Interference mitigating circuit 212 may mitigate interferences so that wireless video communication sink circuit 214 may receive adequate signals while wireless data communication circuit 210 is transmitting.

IMC 212 may mitigate interferences so that wireless data communication circuit 210 may receive adequate signals while wireless video communication sink circuit 214 is transmitting, for example, as may occur during a quiet period of communication source circuit 206 when operating in compliance with WHDI standard but not limited to this example.

Source unit 202 may comprise a wireless video communication source circuit such as wireless video communication source circuit 206. Wireless video communication source circuit 206 may transmit a video signal such as video signal 208.

According to some embodiments, IMC 212 may wait for wireless video communication sink circuit 214 to experience a quiet period before triggering wireless data communication circuit 210 to transmit a signal. The quiet period is a length of time while wireless video communication sink circuit 214 is not receiving a signal, for example if complying with the WHDI standard there is a predefined recurring cycle or period in which wireless data communication circuit 210 may receive is defined as the circuit reception cycle/period and the remaining time is defined as the quiet period. Optionally, if wireless data communication circuit 210 receives a transmission during wireless video communication sink circuit 214 reception cycle/period, IMC 212 may signal wireless data communication circuit 210 to suppress sending an acknowledgement(s). Optionally, wireless data communication circuit 210 may wait for retransmission of unacknowledged transmission. Optionally, while wireless video communication sink circuit 214 is experiencing a quiet period IMC 212 may cause wireless data communication circuit 210 to request retransmission(s) of unacknowledged transmission(s).

Optionally, sink unit 204 may further comprise a pre-amp filter such as pre-amp filter 216. According to some embodiments of the present invention pre-amp filter 216 may be associated with wireless video communication sink circuit 214 may be activated so as to mitigate interference. Wireless video communication sink circuit 214 may trigger pre-amp filter 216 during reception or pre-amp filter 216 may be continuously active. Optionally, wireless data communication circuit 210 may signal to IMC 212 that it is about to transmit or wireless video communication sink circuit 214 may sense transmission of a signal associated with wireless data communication circuit 210 upon either of which the IMC 212 may trigger pre-amp filter 216.

According to some embodiments, pre-amp filter 216 associated with wireless data communication circuit 210 may be activated so as to mitigate interference. Wireless data communication circuit 210 may trigger pre-amp filter 216 during reception or pre-amp filter 216 may be continuously active. Optionally, the wireless video communication sink circuit 214 may signal to IMC 212 that it is about to transmit or wireless data communication circuit 210 may sense transmission of a signal associated with wireless data communication circuit 210 upon any of which IMC 212 may trigger the pre-amp filter 216. Optionally, IMC 212 may track the wireless video communication sink circuit 214 reception/transmission cycles.

According to some embodiments, IMC 212 may limit transmission power of wireless video communication sink circuit 214 while wireless data communication circuit 210 is receiving. The transmission power may be may be limited to a predefined level, for example, a transmission power of approximately 0 dBm.

According to some embodiments, IMC 212 may limit transmission power of wireless data communication circuit 210 while wireless video sink circuit 214 is receiving. The transmission power may be limited to a predefined level, for example, a transmission power of approximately 0 dBm.

Turning now to FIG. 1C, there is shown a communication system such as wireless communication system 300. Wireless communication system 300 is comprised of a source unit such as source unit 302, a sink unit such as sink unit 307 and a video signal such as video signal 312. Source unit 302 further comprises a wireless video communication source circuit such as wireless video communication source circuit 303, an interference mitigating circuit such as interference mitigating circuit 304, a wireless data communication circuit such as wireless communication circuit 305 and optionally a pre-amp filter such as pre-amp filter 306.

Sink unit 307 further comprises a wireless video communication sink circuit such as wireless video communication sink circuit 308, an interference mitigating circuit such as interference mitigating circuit 309, a wireless data communication circuit such as wireless data communication circuit 310 and optionally, a pre-amp filter such as pre-amp filter 311.

The communication system, and its constituent components/circuit, shown in FIG. 1C may be an aggregation of the components/circuits shown in FIGS. 1A & 1B. Accordingly, it should be understood that the functionality of wireless communication system 300, and its constituent components/circuits, may substantially correspond to the combined functionalities of wireless communication system 100 and/or wireless communication system 200, and their respective components/circuits.

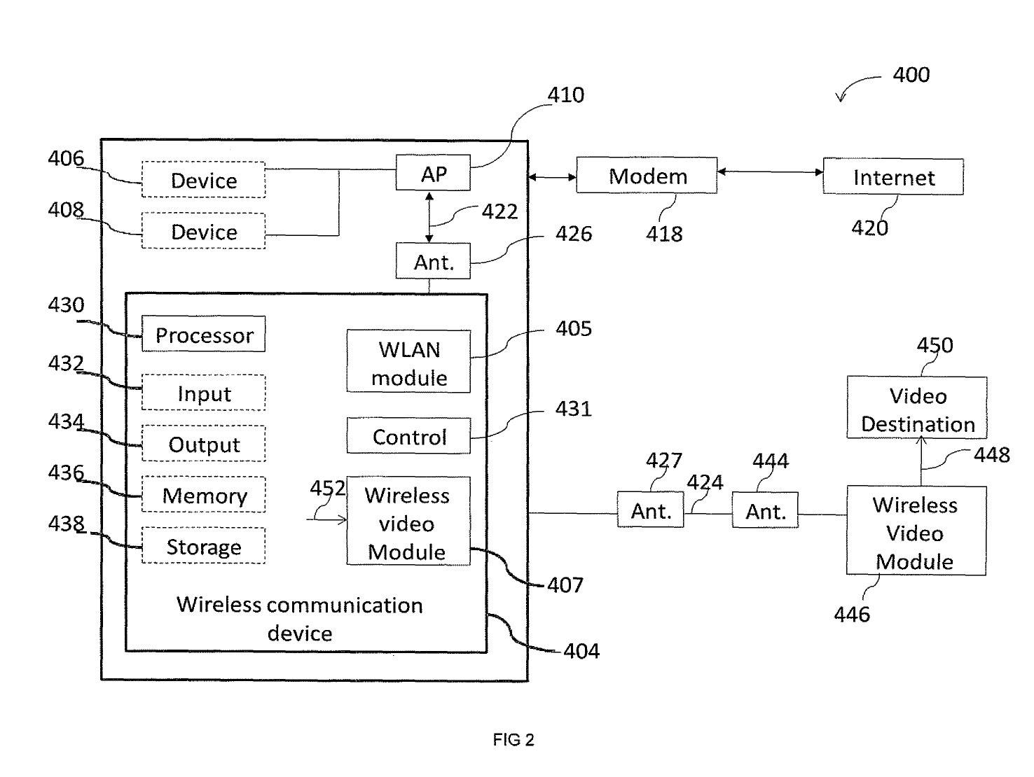

Turning now to FIG. 2, there is shown a block diagram of a communication system such as communication system 400. In some demonstrative embodiments, system 400 may include a wireless network such as WLAN network 402, a modem such as modem 418, a packetized data communication circuit such as internet 420, a wireless video module such as wireless video module 446 and a video destination such as video destination 450.

WLAN network 402 may comprise a wireless communication device such as wireless communication device 404 and an access point such as AP 410.

Wireless communication device 404 optionally may also comprise a device such as device 406 and/or device 408.

Wireless communication device 404 may include a wireless data communication module such as; a wireless video module such as wireless video module 407, a wireless data module such as WLAN module 405, a control mechanism such as control 431. Wireless communication device 404 may optionally further comprise a processor such as processor 430, an input such as input 432, an output such as output 434, a memory such as memory 436 and a storage such as storage 438 and may optionally further include other suitable hardware components and/or software components.

WLAN module 405 may be capable of performing WLAN communications with AP 410 over a WLAN link such as WLAN link 422

Wireless video module 407 may be capable of performing wireless-video communications with a wireless-video module 446 over a wireless-video communication link 424.

In some demonstrative embodiments, WLAN module 405 and wireless video module 407 may be integrally implemented as part of and/or commonly connected to a common communication card, a board, a Printed Circuit Board (PCB), a motherboard, a package, a system on chip (SOC), and the like. In other embodiments, WLAN module 405 and wireless video module 407 may be implemented as separate components of wireless communication device 404.

In some demonstrative embodiments, WLAN module 405 may transmit and/or receive any suitable WLAN communication over WLAN communication link such as WLAN communication link 422, optionally via one or more antennas such as antenna 426. The WLAN communication link 422 may include, for example, RF signals, blocks, frames, transmission streams, packets, beacon packets, WLAN packets, video frames, control signals, messages and/or data but not limited to these examples.

In some embodiments, wireless video module 407 may transmit and/or receive over wireless video communication link 424 wireless signals via one or more antenna(s) such as antenna 427, as described in detail below. The wireless signals transmitted over a communication link such as communication link 424 may include any suitable RF signals, blocks, frames, transmission streams, packets, video frames, control signals, messages and/or data but not limited to these examples.

Antennas 426, 427 and/or 444 may include an internal and/or external RF antenna, a dipole antenna, a monopole antenna, an omni-directional antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data.

In some demonstrative embodiments WLAN network 402 may include one or more other wireless communication devices such as devices 406 and/or 408, capable of communicating with AP 410.

WLAN network 402 may operate in accordance with any suitable standard or protocol, for example, existing Institute-of-Electrical-and-Electronics-Engineers (IEEE) 802.11, 802.11a, 802.11b, 802.11g, 802.11k, 802.11n, and/or 802.11r standards and/or future versions and/or derivatives and/or Long Term Evolution (LTE) of the above standards (“the 802.11 standards”). Accordingly, WLAN communication link 422 may be established in accordance with the 802.11 standards and/or any other suitable WLAN standard or protocol. WLAN module 405 may include, for example, any suitable receiver, transmitter, and/or transceiver, e.g., in the form of a WLAN communication card, in accordance with the 802.11 standards and/or any other suitable WLAN standard or protocol.

In some demonstrative embodiments, AP 410 may be connected to the Internet 420, optionally via modem 418. In some embodiments, AP 410 may communicate to device 404, via the WLAN communication link 422, data received from Internet 420, devices 406 and/or 408, and/or any other suitable source associated with AP 410.

In some demonstrative embodiments, devices 404, 406 and/or 408 may include any suitable portable device and/or non-portable device. In one example, device 404 may be a mobile device, such as: a laptop, a Personal Digital Assistants (PDA), a handheld computer, a notebook computer, a portable game console, a Voice-Over-Internet-Protocol (VoIP) phone, a portable video device, a portable computer, a video camera, a mobile phone, a portable television (TV) tuner, a photo viewer, a media player, a portable video player, a portable DVD player, and/or an MP-4 player and more.

In a further example, device 404 may be the functionality of a non-portable device such as: a desktop computer, a non-portable computer, a workstation, a non-portable video source, a Set-Top-Box (STB), a DVD, a digital-video-recorder, a non-portable game console, a PC, a Video Cassette Recorder (VCR), a non-portable television (TV) tuner, a non-portable media player, a non-portable video player, a portable-video-player, a DVD player, an MP-4 player, a Bluray (BR) disk player, a video dongle, and more but not limited to these examples.

In some demonstrative embodiments, processor 430 may be a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), a combination of some or all of these examples and/or any other suitable multi-purpose or specific processor or controller.

In some demonstrative embodiments, input 432 may be a keyboard, a keypad, a mouse, a touch-pad, a track-ball, a stylus, a microphone, or other suitable pointing device or input device. Output 434 may be a monitor, a screen, a Cathode Ray Tube (CRT) display unit, a Liquid Crystal Display (LCD) display unit, a plasma display unit, one or more audio speakers, a combination of these examples and/or other suitable output devices. Memory 436 may be: a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, and/or other suitable memory units. Storage 438 may be a hard disk drive, a floppy disk drive, a Compact Disk (CD) drive, a CD-ROM drive, a DVD drive, and/or other suitable removable or non-removable storage units. Memory unit 436 and/or storage 436 may store, for example, store data processed by device 404.

In some demonstrative embodiments, some or all of the components of device 404 may be enclosed in a common housing, packaging, or the like, and may be interconnected or operably associated using one or more wired or wireless links. In other embodiments, components of device 404 may be distributed among multiple or separate devices.

In some demonstrative embodiments, wireless video module 407 may transmit via link 424 a downlink (DL) wireless-video transmission including video information corresponding to video signals 452.

In some embodiments, video signals 452 may include video signals internally generated and/or processed by device 404, for example video signals generated and/or processed by processor 430; and/or video signals received from an external source, for example via WLAN module 405, as described below. In one example, memory 436 and/or storage 438 may store at least part of the video information corresponding to video signals 452.

In some embodiments, video signals 452 may include signals of any suitable video format. Video signals 452 may include HDTV video signals, for example, uncompressed HDTV signals, in a Digital Video Interface (DVI) format, a High Definition Multimedia Interface (HDMI) format, a Video Graphics Array (VGA), a VGA DB-15 format, an Extended Graphics Array (XGA) format, and their extensions, or any other suitable video format.

In some demonstrative embodiments, video signals 452 may include video information generated and/or received from one or more sources, e.g., in addition to and/or other than processor 430 and/or device 404. For example, video signals 452 may include video information received over WLAN communication link 422 via WLAN module 405. WLAN module may receive over WLAN communication link 422 WLAN transmissions including video information from AP 410 (WLAN video information). The WLAN video information may include, for example, video information corresponding to a video, a movie, a television program, a network game, and the like. For example, AP 410 may receive and/or retrieve the WLAN video information from Internet 420, devices 406 and/or 408 and/or any other suitable video source associated with AP 410.

In some embodiments, wireless video module 407 may implement any suitable transmission method and/or configuration to transmit the DL wireless-video transmission. Although embodiments of the invention are not limited in this respect, in some demonstrative embodiments, wireless video module 407 may transmit the DL wireless-video transmission using an Orthogonal-Frequency-Division-Multiplexing (OFDM) modulation scheme, a Phase-shift keying (PSK) modulation scheme, a Quadrature amplitude modulation (QAM) scheme, and/or any other suitable transmission and/or modulation scheme. In some demonstrative embodiments, the wireless transmission may include Multiple-Input-Multiple-Output (MIMO) transmission, for example, antenna(s) 427 may include a plurality of antennas.

In some embodiments, wireless video module 407 may also receive via link 424 an uplink (UL) transmission including, for example, any suitable data, control and/or maintenance information from wireless video module 446, for example, during a UL period. A UL period of wireless video module 407 may be included within a Vertical Blanking (VB) period between consecutive frames of the video data. For example, video signals 452 may include no video data during a predefined time period succeeding each video frame (“the VB period”). The VB period may correspond to a time period required for trace back of an electron beam of a Cathode-Ray Tube (CRT),

Although embodiments of the invention are not limited in this respect, according to some demonstrative embodiments, wireless-video communication link 424 may include any suitable wireless communication link. In some embodiments wireless video module 407 may apply a de-correlating transformation, for example a DCT and/or a wavelet, to video signals 452. Wireless video module 407 may perform the de-correlating transform on a plurality of color components optionally, in the format Y-Cr-Cb, representing pixels of video signals 452. In some demonstrative embodiments, the DL wireless-video transmission may include values of fine constellation symbols, and values of coarse constellation symbols.

In some demonstrative embodiments, wireless video module 446 may generate output video signals such as output video signal(s) 448, which may correspond to to video signals 452. For example, wireless video module 446 may be implemented by a wireless-video receiver. Wireless video module 446 may include an antenna(s) such as antenna(s) 444.

Communication system 400 may also include a video destination 450, which may include any suitable software and/or hardware to receive, process, store, and/or handle output video signal(s) 448 in any suitable manner. In one example, video destination 450 may include any suitable video display and/or receiver. For example, video destination 450 a display or screen, such as a flat screen display, a Liquid Crystal Display (LCD), a plasma display, a back projection television, a television, a projector, a monitor, an audio/video receiver, a video dongle, and more. In some demonstrative embodiments, video destination 450 and wireless video module 446 may be implemented as part of video destination module, such that video destination 450 and wireless video module 446 are enclosed in a common housing, packaging, or the like. In other embodiments, video destination 450 and wireless video module 446 may be implemented as separate devices.

In some embodiments, WLAN link 422 may include a communication link over a frequency band, denoted f1. The frequency band f1 may be preset, for example, by AP 410. The frequency band f1 may be located, for example, within a predefined Radio Frequency (RE) band. For example, the predefined RF band may be within an approximate range of 2.4-2.5 Giga Hertz (GHz), in accordance with the 802.11b or 802.11g standards; an approximate range of 49-5.9 GHz, in accordance with the 802.11a or 802.11n standards; and/or any other suitable RF range in accordance with the 802.11 standards and/or any other suitable standard and more.

In some embodiments, wireless video link 424 may include a communication link over a frequency band, denoted f2. For example, wireless video module 407 may select the frequency band f2 from within a predefined RF band, for example, from within the RF band of 4.9-5.9 GHz, and/or any other suitable RF band.

The frequency bands f1 and/or f2 may have any suitable bandwidth, for example, between 20 and 40 Mega-Hertz (MHz).

In some embodiments, wireless video module 407 may be capable of selectively restricting the transmission power used by wireless video module 407 during the DL transmission, for example, in order to fit different applications requiring different transmission distances and/or coverage, to fit both an in-room application and a whole-house application.

In some embodiments, device 404 may be configured to maintain an isolation of about −40 dB or better, between WLAN antenna(s) 426 and wireless video antenna(s) 427. In other embodiments, device 404 may be configured to maintain any other suitable isolation between WLAN antennas 426 and wireless video antennas 427.

In some embodiments, there may be substantially no restriction on the wireless video communication performed by wireless video module 407 if, for example, WLAN module 405 and wireless video module 407 utilize communication links 422 and 424, respectively, within different RF bands. For example, there may be substantially no restriction on the wireless video communication performed by wireless video module 407, if WLAN module 405 utilizes the frequency band f1 within the RF band of 2.4-2.5 GHz; while wireless video module 407 utilizes the frequency band f2 within the RF band of 4.9-5.9 GHz. Accordingly, wireless video module 407 may utilize a maximal transmission power for example for whole home coverage.

In other embodiments, WLAN module 405 and wireless video module 407 may utilize the frequency bands f1 and f2, respectively, within at least partially overlapping RF bands. For example, both frequency bands f1 and f2 may be within at least partially overlapping RF bands if, for example, WLAN module 405 utilizes the frequency band fl within the RF band of 4.9-5.9 GHz, in accordance with the 802.11a or 802.11n standards; and wireless video module 407 utilizes the frequency band f2 within the RF band of 4.9-5.9 GHz.

In some embodiments, frequency allocation and/or transmission power utilized by WLAN module 405 and wireless video module 407 may be configured and/or controlled in order, which may allow the co-existence and/or parallel operation of the wireless communication over links 422 and 424, for example, by reducing and/or avoiding interference between the transmissions over links 422 and 424.

In some embodiments, wireless video module 407 may be capable of selecting the frequency band f2 to be different than the frequency band f1 used by WLAN module 405. For example, a Media-Access-Control (MAC) layer of wireless video module 407 may be capable of selecting, the frequency band f2 to be used by communication link 424.

In some demonstrative embodiments, device 404 may be configured to ensure that a receiver path of one of modules 405 and 407 may not substantially be blocked by a transmitter path of another of modules 405 and 407 (UL/DL blockage). For example a WLAN uplink (UL) communication to WLAN module 405 may not be blocked by the DL communication by wireless video module 407, and/or an UL communication to wireless video module 407 may not be blocked by a DL communication by WLAN module 405. Such UL/DL blockage may be caused, for example, by saturation of a Low-Noise-Amplifier (LNA) filter at the receiver channel path.

In some embodiments, the transmission power of wireless video module 407, may be limited to a predefined level, such as a transmission power of approximately 0 dBm e.g., for example: during the DL transmission period. Such transmission power may still be good enough for short distance and/or in-room coverage of the wireless video communication over link 424. This may ensure that the UL communication to WLAN module 405 will not be blocked by the DL communication of wireless video module 407.

In some embodiments, during the UL period of wireless video module 407, the transmission power of WLAN module 405 may be turned off, or limited to a predefined level, for example, a transmission power of approximately 0 dBm. This may ensure that the UL communication to wireless video module 407 will not be blocked by the communication by WLAN module 405.

In some embodiments, the transmission power of WLAN module 405 during the UL period of wireless video module 407 may be limited to 0 dBm, and the transmission power of wireless video module 407 during the DL transmission period of wireless video module 407 may be limited to 0 dBm.

In some embodiments, the transmission power of WLAN module 405 during the UL period of wireless video module 407, and/or the transmission power of wireless video module 407 during the DL transmission period of wireless video module 407 may be limited to any other suitable predefined transmission power levels, for example, based on any suitable parameter related to device 404, WLAN module 405, wireless video module 407, antenna(s) 426 and/or antenna(s) 427. In one example, the WLAN transmission power level and/or the video transmission power level may be determined based on a level of isolation between WLAN antenna(s) 426 and wireless video antenna(s) 427.

In some embodiments, the WLAN transmission power level and/or the video transmission power level may be configured and/or adjusted manually or automatically, for example, according to requirements of a user of device 404. For example, the WLAN transmission power level and/or the video transmission power level may be adjusted according to a relationship between the quality of the wireless video transmission over link 424 compared to the data rate throughout WLAN link 422. For example, the WLAN transmission power level may be increased and/or the video transmission power level may be decreased if a greater WLAN throughput is required; or the WLAN transmission power level may be decreased and/or the video transmission power level may be increased, if a video quality is required.

In some embodiments, the UL period of module 407 may be synchronized with the VB period of the video data of video signals 452. For example, wireless video module 407 may receive UL communications over link 424 during the VB time period between two video frames of the DL video transmission over link 424.

In some embodiments, the VB period may have a length of, for example, 0.67 milliseconds (ms).

In some embodiments, wireless video module 407 may receive, during at least part of the VB period, UL communications over link 424. For example, the UL period of wireless video module 407 may last for approximately 0.6 ms of the VB period, if video signals 452 correspond to a frame frequency of 60 Hz.

In some embodiments, antenna directionality of antennas 426 and 427 may be configured to achieve relatively high antenna isolation between antennas 426 and antennas 427, thereby reducing and/or eliminating the UL/DL blockage.

In some embodiments, device 404 may include a control mechanism 431 to control the UL and/or DL communications performed by WLAN module 405 and wireless video module 407 and/or synchronize between the UL and/or DL communications performed by WLAN module 405 and wireless video module 407, in order to reduce and/or eliminate the UL/DL blockage.

In some embodiments, control mechanism 431 may be implemented using any suitable software, hardware, and/or firmware. Control mechanism 431 may be included as part of one or more elements of device 404 and/or implemented using one or more dedicated elements.

In some embodiments, control mechanism 431 may include a hardware link directly connecting between a Base-Band (BB) module of WLAN module 405 and BB module of wireless video module 407, such that UL/DL synchronization between the UL and DL transmissions of modules 405 and 407 may be performed at a Physical (PHY) layer and/or or a MAC layer.

In an embodiment, modules 405 and 407 may be configured to be “aware” of one another, and control mechanism 431 may be implemented as part of an Operating System (OS) of device 404.

Control mechanism 431 may be implemented as a pre-antenna or pre-Power Amplifier (PA) RF switch, which may be controlled by the MAC of wireless video module 407 to restrict WLAN transmissions of WLAN module 405 during the UL period of wireless video module 407.

While a number of exemplary aspects and embodiments have been discussed above, those of skill in the art will recognize certain modifications, permutations, additions and sub-combinations thereof. it is therefore intended that the following appended claims and claims hereafter introduced be interpreted to include all such modifications, permutations, additions and sub-combinations as are within their true spirit and scope.

In the description and claims of the application, each of the words “comprise” “include” and “have”, and forms thereof, are not necessarily limited to members in a list with which the words may be associated.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A circuit comprising:
a wireless data communication circuit;
a wireless video communication circuit; and
control logic functionally associated with either of said circuits and adapted to mitigate interference between transmission from one of said circuits with reception by the other circuit.

2. The circuit according to claim 1, wherein said wireless data communication circuit is a packetized data transceiver circuit.

3. The circuit according to claim 2, wherein said wireless data communication circuit is a WiFi compliant transceiver circuit.

4. The circuit according to claim 1, wherein said video communication circuit is a wireless video sink transceiver circuit and is adapted to receive a wireless video transmission.

5. The circuit according to claim 4, wherein said control logic is adapted to signal said data transceiver circuit to operate in a second band mode when said video sink transceiver circuit is receiving a video transmission.

6. The circuit according to claim 4, wherein said control logic is adapted to disable transmission by said data transceiver circuit when said video sink transceiver circuit is receiving a video transmission.

7. The circuit according to claim 4, wherein said control logic is adapted to activate one or more pre-amp filters associated with said video sink transceiver circuit when said data transceiver circuit is transmitting.

8. The circuit according to claim 4, wherein said control logic is adapted to activate one or more pre-amp filters associated with said data transceiver circuit when said video sink circuit is transmitting.

9. The circuit according to claim 1, wherein said video communication circuit is a wireless video source transceiver circuit and is adapted to transmit a wireless video transmission.

10. The circuit according to claim 9, wherein said control logic is adapted to cause said data communication circuit to operate in a second band mode when said video source circuit is transmitting.

11. The circuit according to claim 9, wherein said control logic is adapted to disable transmission by said data communication circuit when said video source transceiver circuit is receiving a transmission.

12. The circuit according to claim 9, wherein said control logic is adapted to activate pre-amp filters associated with said data communication circuit, when said video source transceiver circuit is transmitting a video transmission.

13. A method of mitigating interference between a wireless data communication circuit and a wireless video communication circuit in proximity with one another, the method comprising:
regulating one or more operational parameter of the wireless data communication circuit, the wireless video communication circuit, or both, based on activity of the other.

14. The method according to claim 13, wherein said wireless data communication is a packetized data communication.

15. The method according to claim 14, wherein said wireless data communication is a WiFi compliant communication.

16. The method according to claim 13, wherein said video communication is a wireless video reception.

17. The method according to claim 16, wherein said data communication is transmitted in a second band mode during said wireless video reception.

18. The method according to claim 16, wherein said wireless data communication is disabled during said wireless video reception.

19. The method according to claim 16 wherein said wireless video reception is pre-amp filtered during wireless data communication.

20. The method according to claim 16, wherein said wireless data communication is pre-amp filtered during wireless video uplink transmission.

21. The method according to claim 13, wherein said video communication is a wireless video transmission.

22. The method according to claim 21, wherein said data communication is received in a second band mode during said wireless video transmission,

23. The method according to claim 21 wherein said wireless data communication is disabled during said wireless video transmission.

24. The method according to claim 21, wherein said data is pre-amp filtered during said video transmission.
